(19) United States
(12) Patent Application Publication
(10) Pub. No.: US 2025/0228255 A1
(43) Pub. Date: Jul. 17, 2025

(54) PERFORATED BAKING MAT WITH HANDLES

(71) Applicant: The Rosehill Company LLC, Sacramento, CA (US)

(72) Inventor: Michael Vaona, Eugene, OR (US)

(21) Appl. No.: 18/919,622

(22) Filed: Oct. 18, 2024

Related U.S. Application Data
(60) Provisional application No. 63/619,829, filed on Jan. 11, 2024.

(51) Int. Cl. A21B 3/15; A47J 36/04

(52) U.S. Cl. CPC A21B 3/15; A47J 36/04

(57) ABSTRACT

A baking mat with a perforated baking surface and a nonperforated border around the perforated baking surface. The baking mat also includes handles integrated into the nonperforated border. The perforated baking surface may include a fiberglass mesh coated with an addition-cured silicone and the nonperforated border may also comprise addition-cured silicone.

### CROSS REFERENCE TO RELATED APPLICATIONS

This application claims priority from U.S. Provisional Application Ser. No. 63/619,829, filed Jan. 11, 2024, the entirety of which is incorporated by reference.

### FIELD OF THE INVENTION

This disclosure relates to a reusable mat for lining a baking vessel for baking bread.

### BACKGROUND

Many bakers use parchment paper during the bread making process to rest dough on during proofing, cover dough during proofing, and/or rest bread on during baking.

Parchment paper is not reusable and may need to be folded, creased, cut or otherwise shaped to fit in various baking vessels. It may also result in hot spots that make baking uneven.

### SUMMARY

This disclosure provides a baking mat comprising a perforated baking surface; a nonperforated border around the perforated baking surface; and one or more handles extending from the nonperforated border.

Embodiments include the following alone or in any combination.

The baking mat may comprise an addition-cure silicone coating on the perforated baking surface.

The nonperforated border may comprise an addition-cure silicone.

The perforated baking surface may comprise fiberglass mesh coated with an addition-cured silicone and the nonperforated border around the perforated baking surface may comprise addition-cured silicone.

The one or more handles may be integrated into the non-perforated border.

The one or more handles may comprise a fiberglass mesh extending from the fiberglass mesh of the baking surface coated with addition-cured silicone with non-perforated surfaces.

The one or more handles may comprise solid silicone without reinforcement.

The one or more handles may comprise two handles on opposing sides of the baking surface.

The one or more handles may be generally rectangular and joined to the baking surface at one end of each respective handle.

The one or more handles may each comprise a loop with a first end and a second end connected to the non-perforated border at each respective first end and each respective second end to define a space between each handle and the central baking surface.

The one or more handles may be integrated into the non-perforated border with a curved transition.

The baking mat may have a circular perforated baking surface.

The baking mat may have a generally rectangular perforated baking surface.

The generally rectangular perforated baking surface may comprise rounded corners.

The baking mat may have a perforated baking surface comprising a first rectangle and a second and a third rectangle extending from opposed sides of the first rectangle, wherein the second rectangle and the third rectangle each have a smaller area than the first rectangle.

The baking mat may comprise a first handle extending from the nonperforated margin adjacent to the second rectangle and a second handle extending from the nonperforated margin adjacent to the third rectangle.

The baking mat may comprise a perforated baking surface; a nonperforated border around the perforated baking surface; and one or more handles extending from the nonperforated border wherein the perforated baking surface and the nonperforated border comprise addition-cure silicone.

The baking mat wherein the perforated baking surface and the nonperforated border do not contain reinforcement.

The baking mat may comprise an integral sheet comprising the perforated baking surface and the nonperforated border.

### BRIEF DESCRIPTION OF THE FIGURES

FIG. 1 shows a perforated baking mat with handles according to an embodiment of the disclosure.

FIG. 2 shows a perforated baking mat with handles according to another embodiment of the disclosure.

FIG. 3 shows a perforated baking mat with handles according to another embodiment of the disclosure.

FIG. 4 shows a perforated baking mat with handles according to another embodiment of the disclosure.

FIGS. 5-7 show perforated baking mats with openings or cutouts near the handles according to other embodiments of the disclosure.

### DETAILED DESCRIPTION

A perforated baking mat with handles was developed to replace parchment paper during the bread-making process.

The baking mat is intended to replace parchment paper but has two key features—a perforated baking surface surrounded by a non-perforated margin or border—that make it better than parchment paper for baking bread. Further, the baking mat has one or more handles extending from the non-perforated border.

As used herein, the term “about” means that a given dimension such as a diameter may have a measurement that varies from the recited value by +5%, 10% or 20%.

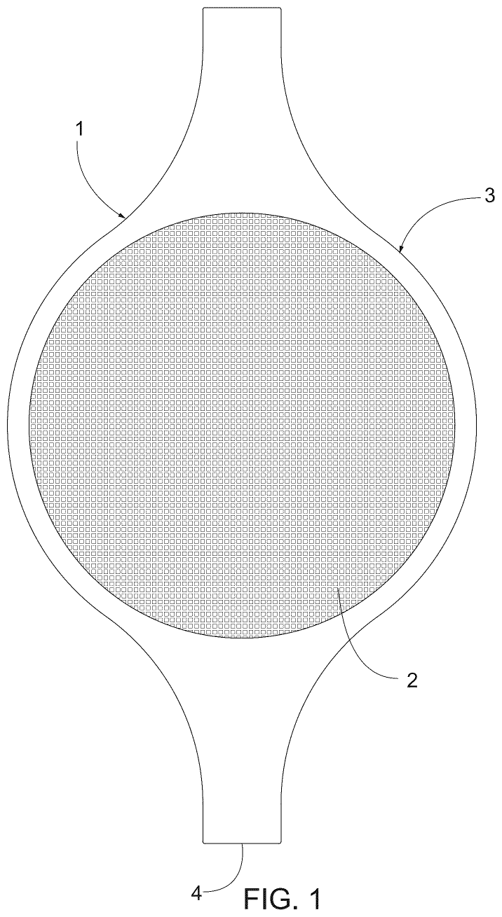

As shown in FIG. 1, the shape of the baking mat 1 was designed to fit many bread baking vessels used by, and loaf sizes baked by, home bakers. Research was conducted by surveying hundreds of bakers about baking vessels and loaf sizes of choice. The most common baking vessel brands and sizes of loaf were identified, and the perforated baking mat was designed to ensure a proper fit in all the common vessels and with the common loaf sizes without folding or creasing. Testing was completed using variations of vessels sizes and dough sizes to cover the most typical scenarios.

A common issue when using parchment paper is localized burning from hot-spots. A second drawback of parchment paper is that the loaf can stick to the parchment paper.

The perforations of the baking mat aid in even heat distribution under the bread during baking which produces an even browning on the bottom of the loaf by limiting hotspots. The surface is also non-stick, meaning the finished bread does not stick to the mat after baking. The perforated surface additionally limits the heat retained by the baking mat, making it cool enough to touch directly out of the oven.

An exemplary baking mat 1 is illustrated in a top view in FIG. 1 and includes a perforated circular baking surface with a solid silicone border. As shown in FIG. 1 for example but not limitation, the circular central area has a diameter of about nine inches (about 230 mm). Without limitation, the perforated baking surface 2 in the example shown in FIG. 1 has diameter of about 8.3 inches (about 210 mm) surrounded by a solid silicone border 3. The border extends into two handles 4 on diametrically opposed sides of the baking surface. As shown, the solid silicone border of the central area tapers into the extended handles with a smooth curve transition, but this is not limiting. For example, the handles may be generally rectangular and extend from the circular central area without a curved transition.

As used herein, a “rectangle” is a two-dimensional shape in which the opposite sides are parallel and equal to each other, and all four angles are right angles. The term “generally rectangular” as used herein refers to a shape approximating a rectangular form with one or more variations such as a non-square corner or a convex or concave side.

A plurality of perforations in the baking surface 2 of the baking mat aid in even heat distribution under the bread during baking, which produces an even browning on the bottom of the loaf by limiting hot-spots. The surface is also non-stick, meaning the finished bread does not stick to the mat after baking; sticking can happen when baking with parchment paper. Perforations in the baking surface are shown in the Figures herein as square-shaped but that is not limiting. Perforations may have regular shapes including circular, rectangular, diamond-shaped (rhomboidal), polygonal (such as hexagonal), irregular shapes, or any combinations thereof. Further, the perforations may be arranged in a regular or irregular pattern. Each of the plurality of perforations may have dimensions of about 1-2 mm across with an area of about 1-4 mm².

The mat may have a thickness of about 1 to 10 mm, such as 1 to 3 mm, 3 to 10 mm, such as 4 to 10, 5 to 10 mm, 4 to 8 mm, 5 to 8 mm, or 5 to 6 mm.

The mat may comprise a mesh substrate for the perforated baking surface comprising a fibrous material 0.5-2.5 mm thick that is woven to create a perforated sheet and then coated with silicone to a final coated thickness of 1-3 mm. Without limitation, the fibrous material for the substrate may be selected from among fiberglass, carbon fibers, stainless steel, aluminum, fibers comprising polymeric materials including aramid, polyamides (nylon), high-temperature aromatic polyesters, or others. Although described herein primarily as a woven fibrous material, the mesh substrate may comprise knitted or nonwoven fibers. Alternatively, the substrate may comprise a sheet fabricated with perforations that are further coated with a coating such as described below.

In a notable embodiment, a 0.5-2 mm spacing between perforations in the perforated baking surface and food-safe, high temperature addition-cure silicone-coated fiberglass provides an excellent combination of strength, including tear strength, surface finish, flexibility, and thermal properties. Addition-cure, room temperature-curing silicones cure to flexible, high-strength elastomers. Although the silicones can be cured at room temperature, cure times can be reduced with heating. Addition-cure silicone (also known as platinum-cure silicone or platinum silicone) is a polymeric material where a multifunctional silicon hydride-containing silicone copolymer and a difunctional vinyl-containing siloxane polymer react in the presence of a complex platinum catalyst. The platinum catalyzes a hydrosilation reaction in which a silicon-hydrogen bond is added across the unsaturated bond of the vinyl group to provide a crosslinked elastomeric network. A platinum-catalyzed system is made up of two silicone elastomer base parts, typically both of equal weight. One part contains the platinum catalyst and the other part contains the crosslinker.

The addition-cure silicone is rated to about 500° F. Food safety can be determined using standards and tests established by the FDA (US Food and Drug Administration) or LFBG (Lebensmittel-, Bedarfsgegenstände-und Futtermittelgesetzbuch, or “Foods, Consumer Goods and Feedstuffs Code, the German enactment of European law as operated by the Bundesinstitut für Risikobewertung (BfR)).

The baking mat may be prepared by cutting a fiberglass mesh mat in the desired shape and coating the mesh with a two-part platinum curable silicone. The silicone may be cured at room temperature for about 24 hours. As described above, the mesh in the baking surface 2 is coated with a thin layer of the silicone to provide perforations in the baking surface. At the border and handle areas, the coating is configured to provide a solid, non-perforated surface for strength and stability.

The baking mat may be prepared using the following representative process. A fiberglass mesh coated with silicone and having the desired spacing between perforations is cut, such as by die-cutting, to a desired size and shape. The size and shape are configured to provide a perforated baking surface having a desired area plus a margin around the entire area of the baking surface to support the solid silicone border. The overall shape may also include shapes for the handles. The fiberglass mesh is coated with silicone comprising additives to provide platinum curing. The silicone may be colored to provide a more uniform appearance. The mat is coated with silicone using a tool to mask the baking area so that it remains perforated while the margins are coated to fill the perforations in the margins. The mat is cut, such as by die-cutting, to the final size and shape. The edges are dipped in clear, colorless silicone using the colored silicone as a guide to fully coat and seal the edges. The sealing performed at the edges of the baking mat creates a solid silicone border 3 to seal what would otherwise be exposed fiberglass and prevent additional silicone from encroaching from the edge of the baking mat, maximizing the amount of perforated area in the area where the bread is baked. Optionally, the solid areas of the mat may be printed with indicia, text, logos, etc. and the printed area coated again with clear silicone to seal the printed areas.

In an alternative process, the fiberglass mat may be die-cut to a desired size and shape and then overmolded with silicone so that the baking surface remains perforated, and the margins are solid silicone where the mesh does not extend into the margins. The mat can be die-cut to its final shape and size including the one or more handles. Alternatively, the shape of the overmolding mold may correspond to the final shape and size so that cutting the mat may not be needed. Because the mesh does not extend into the border and handles, the handles may be trimmed without exposing fiberglass at the edges of the mat. Printing and sealing over the printing may be carried out as described above.

The handles 4 make it easy for the baker to lift the bread dough into and out of its baking vessel. The processes described above fully coat the handles in solid silicone, making the handles strong and durable. In the example shown in FIG. 1, each handle extends about three inches beyond the solid border 3 of the baking mat, providing a mat with a total length of about 15 inches. The handles are about two inches wide at their ends.

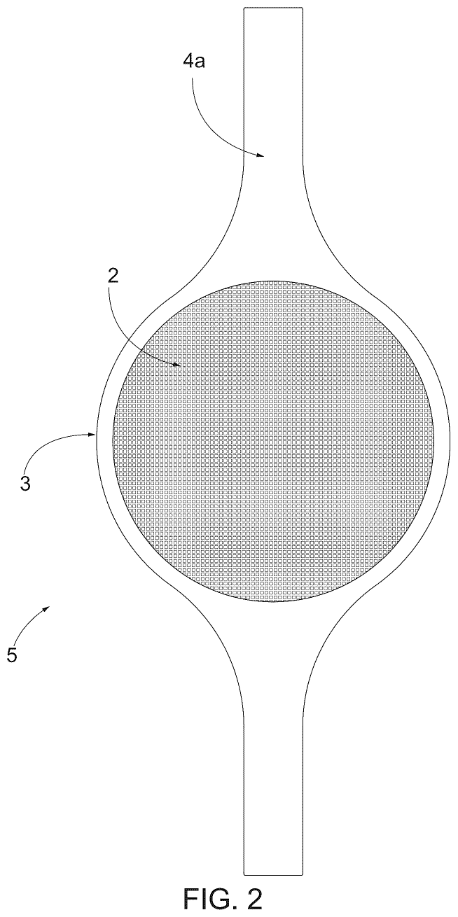

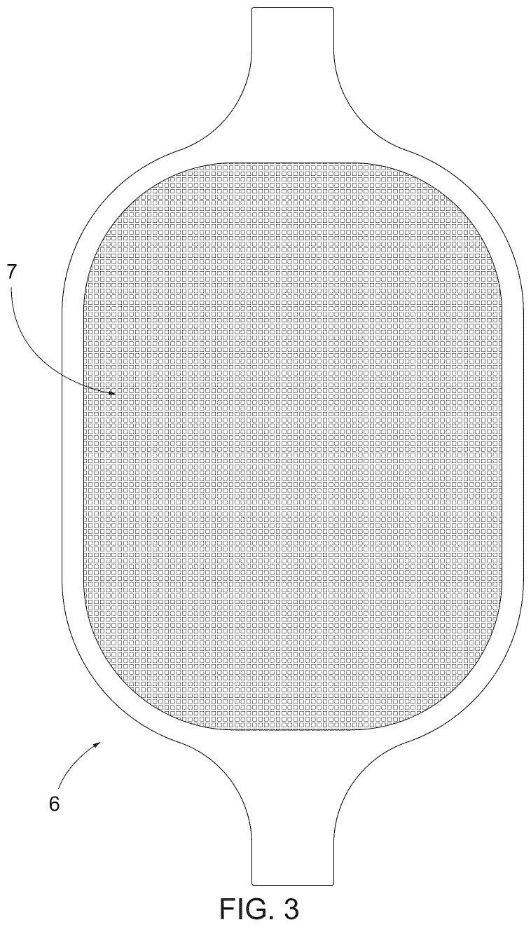

Additional sizes and shapes include but are not limited to baking mats 5 (FIG. 2) that have longer handles for deeper baking vessels and baking mats 6 (FIG. 3) that fit larger specialty baking vessels. The baking mat 5 has a circular central area 2 about nine inches in diameter with extended handles 4a, about 6.5 inches each, in a total length of about 22 inches. FIG. 3 shows a baking mat 6 with a generally rectangular baking area 7 having rounded corners with dimensions of about 8.5 by 11 inches, but this is not limited, and can be varied depending on the size of the baking vessel to be lined by the mat. Baking mats may also be configured with oval baking surfaces (not shown).

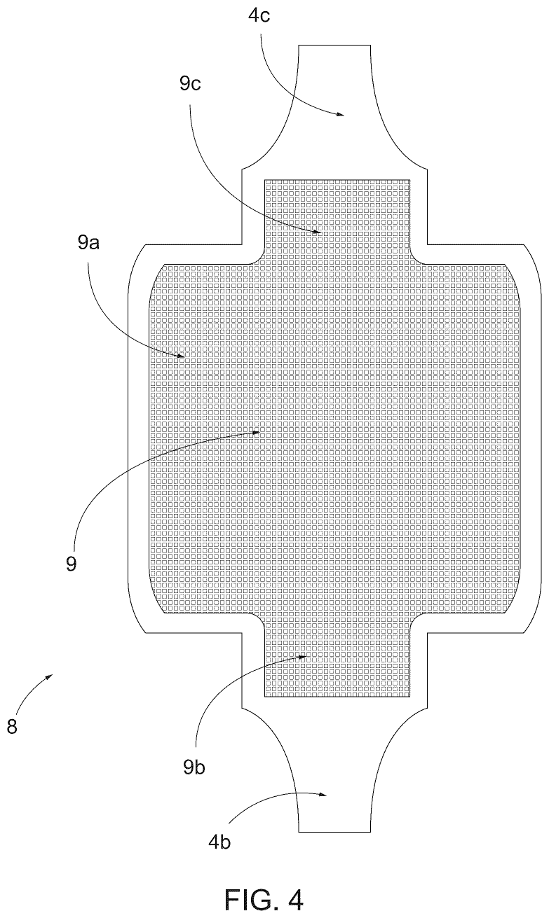

The baking mats 1, 5 and 6 are configured to line the bottom of a baking vessel with the perforated baking surface at the bottom and the handles extending up the side of the vessel to enable a baker to grasp the handles and lift the mat and the bread loaf out of the vessel after baking. FIG. 4 shows a baking mat 8 configured to line a loaf pan. In the baking mat 8, the perforated baking surface 9 is configured to line the bottom and sides of a rectangular loaf pan. The baking surface 9 comprises a first rectangle 9a and a second rectangle 9b and a third rectangle 9c extending from opposed sides of the first rectangle, wherein the second rectangle and the third rectangle each have a smaller area than the first rectangle. As shown in FIG. 4, the rectangles are generally rectangular, with rounded corners at the intersections between the first rectangle and the second and third rectangle. The first rectangle is also shown with convex sides. In this mat, the first rectangle is sized to line the bottom and the two longer sides of the loaf pan. The second and third rectangles are configured to line the two shorter sides of the loaf pan. For example but not limitation, for a loaf pan having internal dimensions of about 3 inches wide, 8 inches long and 2.5 inches deep, the first rectangle, including the solid border, may have dimensions of about 8 inches by about 7 inches and the second and third rectangles may have dimensions of about 3 by 2.5 inches. The baking mat 8 comprises a first handle 4b extending from the nonperforated margin adjacent to the second rectangle 9b and a second handle 4c extending from the nonperforated margin adjacent to the third rectangle 9c.

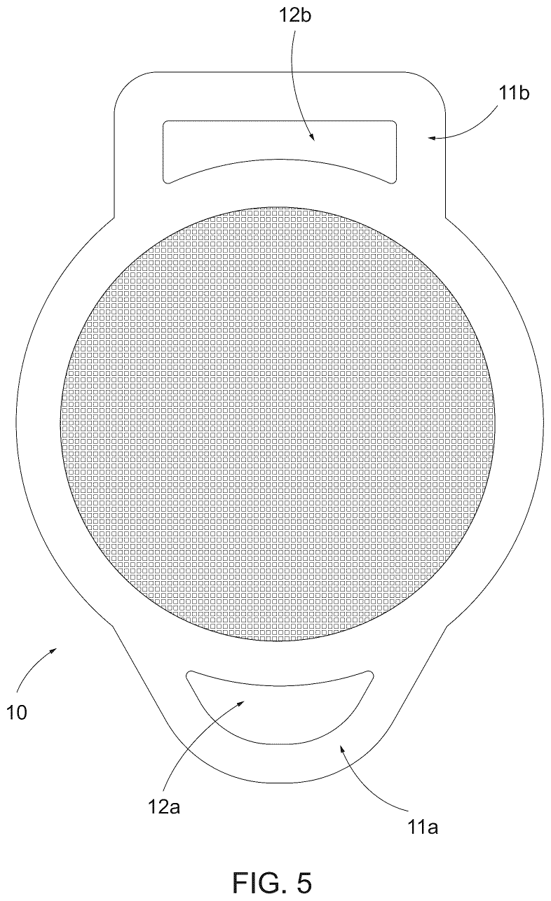

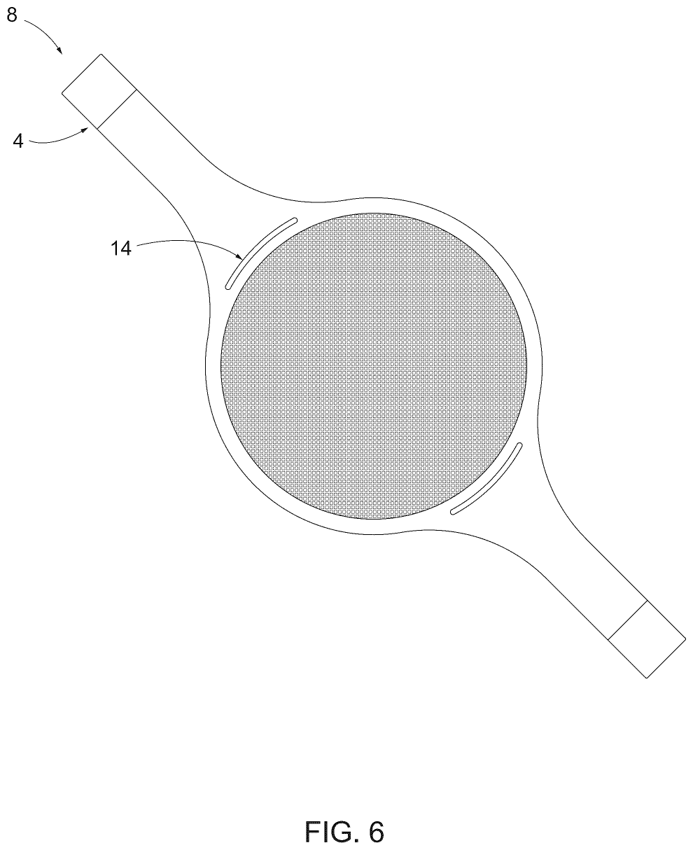

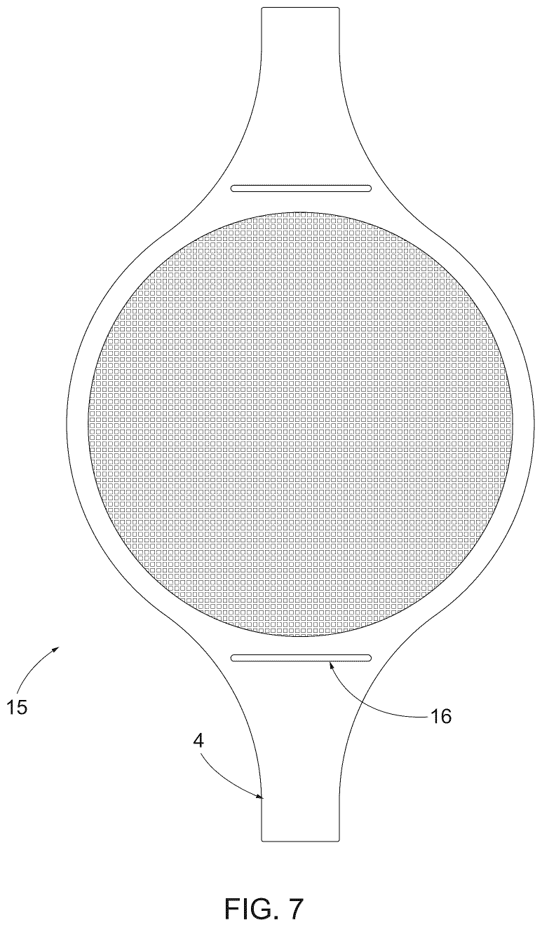

Other shapes for baking mats include mats with cutouts such as openings or slits shown in FIGS. 5-7. A baking mat 10 with loops 11a or 11b for handles defining openings 12a and 12b is shown in FIG. 5. For illustration, FIG. 5 shows two different loop handles 11a and 11b, but a baking mat 10 typically would have two identical loop handles. Mats 13 and 15 include slots or cutouts 14 and 16 respectively near the handles 4 are shown in FIGS. 6 and 7.

The openings 12a, 12b or slots 14, 16 are included such that when the baking mat is lifted by the handles, the weight of the bread opens the internal cutouts and prevents a single axis of bending in the mat. Without the cutouts, the mat could fold in half along the middle, a common occurrence when using parchment paper.

In other embodiments, the baking mat may comprise a mat with a perforated baking surface that does not comprise a mesh substrate. For example, a mold having a shape complementary to the final shape, including projections to create perforations or voids in an otherwise solid sheet, can be used to form a mat with a perforated baking surface and a solid border including handles integrated into to border. The molding process could comprise injection molding using an enclosed mold, or a tray-shaped mold wherein the molding composition is poured into the mold. Uncured silicone is introduced into the mold and cured to form an integral sheet with the perforations formed by the mold. In related molding processes, a mesh substrate can be laid into a mold with projections passing between openings in the mesh and then the silicone molding compound is introduced into the mold around the projections and the substrate to provide a baking mat with reinforcements in the perforated baking surface.

In other embodiments, the perforated baking surface may be prepared by laying down a nonwoven mat of silicone, the margins of which can be coated with silicone to provide the nonperforated margins and integral handles.

In other embodiments, the baking mat may be prepared as an integral sheet with perforations formed by stamping with a die configured with projections in the desired perforation pattern and an outline of the final shape of the mat.

In other embodiments, the perforations can be prepared using a laser or lasers to perforate a solid sheet of silicone. The process can be discontinuous or continuous by passing a silicone sheet from a supply roll through a laser perforation station, followed by cutting the perforated sheet into the final shape.

In other embodiments, the baking mats can be prepared in a continuous process by laying down a liquid silicone composition between a heated nip roll and a platen roll patterned with a plurality of projections in a desired pattern to form the perforated baking surface. The platen can be configured so that there are spaces between the pattern of projections to provide for the solid borders around the perforations. The silicone can be cured when heated by the nip roll. Finally, the continuous perforated sheet can be cut into the final shapes of the mats by cutting the solid spaces between the perforations.

In still other embodiments, the baking mat may comprise a perforated baking surface that is not coated with silicone. For example, the perforated baking surface may comprise a flexible fabric of woven or knitted metal fibers, such as stainless steel or aluminum. In other embodiments, the perforated baking surface can be prepared by stamping perforations into a metal sheet. The thickness for the perforated baking surface may be 1-3 mm. A nonperforated silicone border and integral handles can be applied to the margins of the baking surface by masking the perforated baking surface and coating the margins with silicone as described above. The baking surface can be disposed in the bottom of a baking vessel, while the border is flexible to allow the integrated handles to extend up the sides of the baking vessel to enable a user to grasp them to lift the loaf and mat out of the baking vessel.

The baking mats as disclosed herein can be used to bake loaves of bread by placing the mat in the bottom of a baking vessel such as a Dutch oven, skillet, crock pot, loaf pan or other commercial baking vessels, placing a loaf of unbaked bread dough on the bread mat and heating the baking vessel in a heated space such as an oven for time sufficient to bake the bread dough.

The baked loaf can be lifted from the baking vessel by grasping the one or more handles and lifting the mat and loaf from the baking vessel.

What is claimed:

1. A baking mat comprising a perforated baking surface; a nonperforated border around the perforated baking surface; and one or more handles extending from the nonperforated border.

2. The baking mat of claim 1 wherein the mat comprises an addition-cure silicone coating on the perforated baking surface.

3. The baking mat of claim 1 wherein the nonperforated border comprises an addition-cure silicone.

4. The baking mat of claim 1 wherein the perforated baking surface comprises fiberglass mesh coated with an addition-cured silicone and the nonperforated border around the perforated baking surface comprises addition-cured silicone.

5. The baking mat of claim 1 wherein the one or more handles are integrated into the non-perforated border.

6. The baking mat of claim 5 wherein the one or more handles comprise a fiberglass mesh extending from the fiberglass mesh of the baking surface coated with addition-cured silicone with non-perforated surfaces.

7. The baking mat of claim 5 wherein the one or more handles comprise solid silicone without reinforcement.

8. The baking mat of claim 1 wherein the one or more handles comprise two handles on opposing sides of the baking surface.

9. The baking mat of claim 1 wherein the one or more handles are generally rectangular and joined to the baking surface at one end of each respective handle.

10. The baking mat of claim 1 wherein the one or more handles each comprise a loop with a first end and a second end connected to the non-perforated border at each respective first end and each respective second end to define a space between the handle and the central baking surface.

11. The baking mat of claim 1 wherein the one or more handles are integrated into the non-perforated border with a curved transition.

12. The baking mat of claim 1 having a circular perforated baking surface.

13. The baking mat of claim 1 having a generally rectangular perforated baking surface.

14. The baking mat of claim 13 wherein the generally rectangular perforated baking surface comprises rounded corners.

15. The baking mat of claim 1 having a perforated baking surface comprising a first rectangle and a second rectangle and a third rectangle extending from opposed sides of the first rectangle, wherein the second rectangle and the third rectangle each have a smaller area than the first rectangle.

16. The baking mat of claim 15 comprising a first handle extending from the nonperforated margin adjacent to the second rectangle and a second handle extending from the nonperforated margin adjacent to the third rectangle.

17. The baking mat of claim 1 comprising a perforated baking surface; a nonperforated border around the perforated baking surface; and one or more handles extending from the nonperforated border wherein the perforated baking surface and the nonperforated border comprise addition-cure silicone.

18. The baking mat of claim 17 wherein the perforated baking surface and the nonperforated border do not contain reinforcement.

19. The baking mat of claim 17 comprising an integral sheet comprising the perforated baking surface and the nonperforated border.
